(19) United States
(12) Patent Application Publication
(10) Pub. No.: US 2006/0250367 A1
(43) Pub. Date: Nov. 9, 2006

(54) Keyboard with detachable module

(75) Inventors: Alain Tabasso, Essertines (CH); Sergio Lazzarotto, Marin (CH); Patrick Monney, Mex (CH); Peter Sheehan, County Wicklow (IE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Logitech Europe S.A., Romanel-sur Morges (CH)

(21) Appl. No.: 11/123,839

(22) Filed: May 4, 2005

(51) Int. Cl. G09G 5/00

(52) U.S. Cl. 345/168

(57) ABSTRACT

Embodiments of the present invention provide a detachable module for a computer keyboard to provide additional functionalities and enhance the usage of the computer. In one embodiment a keyboard comprising a keyboard module including a keyboard body having a plurality of input keys for providing input to a processing device; and a detachable module detachably connected to the keyboard body of the keyboard module, the detachable module including at least one of a display or at least one input member for providing input to the processing device and/or the keyboard module. In a docked mode, the detachable module is connected to the keyboard body. In an undocked mode, the detachable module is disconnected from the keyboard body. In the docked mode, the detachable module interacts with the keyboard module to perform one or more functions based on interaction between the detachable module and the keyboard module and/or to transfer data between the detachable module and the keyboard module.

### CROSS-REFERENCES TO RELATED APPLICATIONS

Not applicable.

### BACKGROUND OF THE INVENTION

This invention relates to computer keyboards (corded or wireless) and, more particularly, to a computer keyboard having a detachable module to provide additional functionalities and enhance the usage of the computer.

The personal computer (PC) is being used more frequently as a media center (e.g., a HiFi installation), communication center, and the like. To more fully utilize the PC and provide more versatility of user control, additional devices or features will need to be implemented.

### BRIEF SUMMARY OF THE INVENTION

Embodiments of the present invention provide a detachable module for a computer keyboard to provide additional functionalities and enhance the usage of the computer.

An aspect of the present invention is directed to a keyboard comprising a keyboard module including a keyboard body having a plurality of input keys for providing input to a processing device; and a detachable module detachably connected to the keyboard body of the keyboard module, the detachable module including at least one of a display or at least one input member for providing input to the processing device and/or the keyboard module. In a docked mode, the detachable module is connected to the keyboard body. In an undocked mode, the detachable module is disconnected from the keyboard body. In the docked mode, the detachable module interacts with the keyboard module to perform one or more functions based on interaction between the detachable module and the keyboard module and/or to transfer data between the detachable module and the keyboard module.

In some embodiments, the detachable module is active to provide input to the processing device and the keyboard module is inactive when the detachable module is in the undocked mode. Alternatively, the detachable module is active to provide input to the processing device and the keyboard module is active to provide input to the processing device when the detachable module is in the undocked mode. The detachable module and the keyboard module have independent electronics which are independently active in the undocked mode. The detachable module is configured to communicate with the processing device via a wireless link. Alternatively, the keyboard module is configured to communicate with the processing device via a wired link and to be a wireless transceiver of the detachable module.

In specific embodiments, the detachable module operates on a battery installed therein. The detachable module includes a rechargeable power module which is recharged via electrical contact with the keyboard module when the detachable module is connected to the keyboard module in the docked mode. The detachable module includes a rechargeable power module which is recharged inductively in proximity with the keyboard module.

A security access member may provide secured access to the detachable module. The security access member may provide secured access to the keyboard module. The security access member may provide secured access to at least one of the detachable module or the keyboard module for communication with the processing device. The security access member may comprise a fingerprint reader. The security access member in the detachable module may store data to verify user input to provide security access.

In some embodiments, the at least one input member comprises at least one of a button, a knob, a roller, or a keypad. The detachable module includes at least one input member for providing input to the processing device and/or the keyboard module, the at least one input member performing an identical function in the docked mode and the undocked mode. Alternatively, the detachable module includes at least one input member for providing input to the processing device and/or the keyboard module, the at least one input member performing different functions in the docked mode and the undocked mode. The detachable module does not communicate with the keyboard module in the undocked mode. The detachable module is configured to communicate with the processing device in the undocked mode. The detachable module further comprises a memory card reader.

### BRIEF DESCRIPTION OF THE DRAWINGS

FIG. 1 is a perspective view of a keyboard according to an embodiment of the present invention.

FIG. 2 is a schematic view of the keyboard of FIG. 1 in a computer system according to an embodiment of the present invention.

FIG. 3 is a schematic view of the keyboard of FIG. 1 in a computer system according to another embodiment of the present invention.

FIG. 4 shows another embodiment of a detachable module having a rechargeable battery.

FIG. 5 shows another embodiment of a detachable module having a memory card reader for the keyboard.

FIG. 6 shows another embodiment of a detachable module having a processor and a memory.

### DETAILED DESCRIPTION OF THE INVENTION

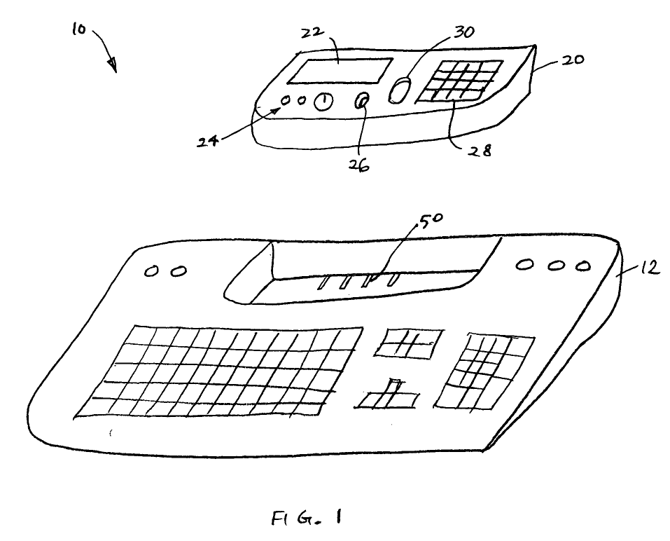

FIG. 1 shows a computer keyboard 10 including a keyboard module 12 with a body or housing and a plurality of input keys for providing input to a processing device such as a PC. The keyboard 10 includes a detachable module 20, which may include an LCD display 22, may include one or more of a plurality of input members such as buttons and knobs 24, a roller 26, and a keypad 28, and may include a security access member such as a finger print reader 30, and the like. One of the input members may be a volume control dial for controlling an audio volume of the computer. There may be a roller 26 for cursor control, scrolling, or the like. The detachable module 20 has two modes of operation: the docked mode on the keyboard module 12 and the undocked mode away from the keyboard module 12.

In the undocked mode, the detachable module 20 may provide a variety of different functionalities. For example, it may serve as a multi-media control module, a PC remote control, a PC communication pager, a mobile device with embedded memory that may feature a memory card reader, a mobile security access device such as a finger print reader, a pointing device, a secondary display. The detachable module includes all the buttons and command features needed to perform its function (e.g., to drive the media player as a multi-media control module, to perform remote control of the PC, etc.), such as volume control, cursor control, keypad, and the like. The detachable module 20 may or may not communicate with the keyboard module 12 in the undocked mode. In addition, the detachable module 20 may or may not communicate with the processing device in the undocked mode.

In the docked mode, the detachable module 20 works as a part of the keyboard 10, interacting with the keyboard module 12 to provided any of a number of functionalities. For instance, the PC remote control will become the keyboard media center; the PC communication pager will become the keyboard communication center; the mobile device with embedded memory will become the keyboard embedded memory or memory card reader; the mobile security access device will become the keyboard security access module such as a keyboard finger print reader module; the pointing device will become the keyboard pointing device for cursor control, scrolling, or the like; and the secondary display will become the keyboard's secondary display.

The keyboard module 12 may be inactive when the detachable module 20 is undocked, if they share the same electronics. On the other hand, the keyboard module 12 may stay active (to provide input to the computer) with the detachable module in the undocked mode if they have independent electronics. The industrial design of the detachable module 20 and the industrial design of the keyboard module 12 will share an integrated design and feature language. This means that in terms of industrial design (shape, material, connectivity, integration of the functions of the detachable module 20 and the keyboard module 12), both modules will feature a high level of integration. For example, the connectivity of the detachable module 20 when docked with the keyboard module 12 can be hidden, and a hidden eject button or the like can be provided in the keyboard module 12 to eject the detachable module. Some of the input members (e.g., buttons, dials, and the like) and/or features of the detachable module may share the same functions between the docked mode and the undocked mode, or they may perform different functions between the docked mode and the undocked mode. For instance, an input member of the detachable module 20 may interact with the keyboard module 12 in the docked mode to perform keyboard functions (e.g., scrolling, cursor control, and the like), and may perform different remote control functions of the processing device in the undocked mode. The detachable module 20 may include an internal switch which is switched between a docked position and an undocked position, and determines the different functions to be performed between the docked mode and the undocked mode.

The communication between the detachable module 20 and the computer may be wired or wireless (e.g., IR or RF). In one embodiment as shown in FIG. 2, the communication between the detachable module 20 and the computer 40 is based on RF mono-directional or bidirectional technology. The computer 40 includes an RF receiver 42. In another embodiment where the keyboard module 12 is a corded keyboard module connected to the PC 40 by a wired connection as seen in FIG. 3, the keyboard module 12 may be the RF transceiver of the detachable module 20 (instead of the RF receiver). In the docked mode, the detachable module 20 is in place in the keyboard 10, and the keyboard frame membranes are in contact with the RF electronics on the detachable module, allowing the scanning of keycaps and full keyboard functionality. When the detachable module 20 with the RF electronics is not in place in the keyboard 10 in the undocked mode, the keyboard module 12 may become inoperable in one embodiment, and it may remain operable in another embodiment with its own RF electronics on board or with a cable connection to the computer.

Alternatively, the detachable module 20 may be a simple module with an LCD (without an RF link). The detachable module downloads a piece of information from the computer in the docked mode, and retains that information in the undocked mode. As an example, one may have a database with a number of kitchen recipes and one is selected and downloaded to the detachable module. The detachable module 20 is then removed from the keyboard 10 and taken to the kitchen so that the recipe can be displayed on the LCD during preparation of the recipe in the kitchen.

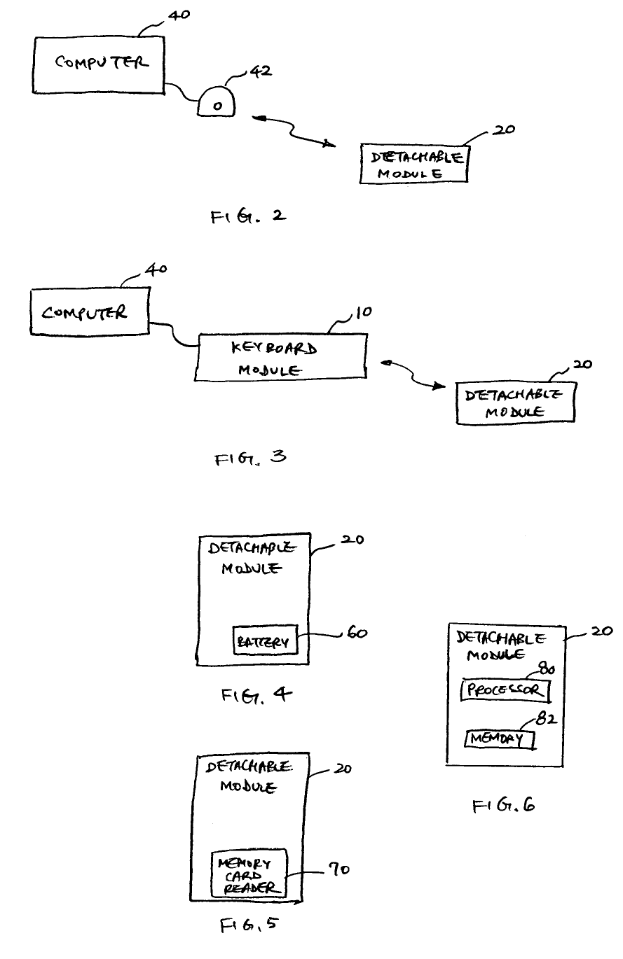

The detachable module 20 may be self-powered with independent batteries. In another embodiment as shown in FIG. 4, the detachable module 20 is powered or recharged by the keyboard module 12 (corded) in the docked mode (see FIG. 1). The module 20 may include a small rechargeable battery or super capacity 60 to store a reasonable amount of energy. The detachable module rechargeable battery 60 may be recharged via electrical contact (50 in FIG. 1) with the keyboard module 12 or inductively with no contact required.

Providing the detachable module 20 in the keyboard 10 enhances the usage of the PC 40, for instance, as a home media center that is controllable from different locations in the home. The present keyboard 10 offers high end functionalities. Those functionalities can be taken from the keyboard as on-board functionalities of the detachable module while the keyboard remains active. The detachable module may function as a separate device and offer various types of functionalities. FIG. 5 shows another example of a detachable module 20 having a memory card reader 70 for the keyboard. Moreover, the detachable module can take the form of a desk usage model, a home PC control model, a mobile usage model, or the like. Advantageously, the detachable module may be sold separately as future extensions of the desktop computer or keyboard.

FIG. 6 shows another embodiment of a detachable module 20 having a processor 80 and a memory 82. The processor 80 enables the detachable module 20 to perform various processes as discussed above, and to function independently in the undocked mode. The memory 82 can be used to store programs and/or data, etc. For example, The memory 82 may be used to store information to verify the user's access as read by the fingerprint reader 26 in FIG. 1. The detachable module 20 can be secured in both the docked mode and the undocked mode. To activate the detachable module 20, the fingerprint reader 26 needs to read from the user's finger the appropriate fingerprint information that matches what is stored in the memory 82. In the docked mode, this can be required to activate the keyboard module 12 as well.

The above-described arrangements of apparatus and methods are merely illustrative of applications of the principles of this invention and many other embodiments and modifications may be made without departing from the spirit and scope of the invention as defined in the claims. For instance, other examples of remote functions performed by the detachable module and interactions between the detachable module and the keyboard module may be found in U.S. patent application Ser. No. 10/885,935, entitled “Communication Zone on a Keyboard,” filed Jul. 6, 2004, the entire disclosure of which is incorporated herein by reference. The scope of the invention should, therefore, be determined not with reference to the above description, but instead should be determined with reference to the appended claims along with their full scope of equivalents.

What is claimed is:

1. A keyboard comprising:
a keyboard module including a keyboard body having a plurality of input keys for providing input to a processing device; and
a detachable module detachably connected to the keyboard body of the keyboard module, the detachable module including at least one of a display or at least one input member for providing input to the processing device and/or the keyboard module;
wherein in a docked mode, the detachable module is connected to the keyboard body;
wherein in an undocked mode, the detachable module is disconnected from the keyboard body; and
wherein in the docked mode, the detachable module interacts with the keyboard module to perform one or more functions based on interaction between the detachable module and the keyboard module and/or to transfer data between the detachable module and the keyboard module.

2. The keyboard of claim 1 wherein the detachable module is active to provide input to the processing device and the keyboard module is inactive when the detachable module is in the undocked mode.

3. The keyboard of claim 1 wherein the detachable module is active to provide input to the processing device and the keyboard module is active to provide input to the processing device when the detachable module is in the undocked mode.

4. The keyboard of claim 3 wherein the detachable module and the keyboard module have independent electronics which are independently active in the undocked mode.

5. The keyboard of claim 1 wherein the detachable module is configured to communicate with the processing device via a wireless link.

6. The keyboard of claim 5 wherein the keyboard module is configured to communicate with the processing device via a wired link and to be a wireless transceiver of the detachable module.

7. The keyboard of claim 1 wherein the detachable module operates on a battery installed therein.

8. The keyboard of claim 1 wherein the detachable module includes a rechargeable power module which is recharged via electrical contact with the keyboard module when the detachable module is connected to the keyboard module in the docked mode.

9. The keyboard of claim 1 wherein the detachable module includes a rechargeable power module which is recharged inductively in proximity with the keyboard module.

10. The keyboard of claim 1 wherein the detachable module further comprises a security access member to provide secured access to the detachable module.

11. The keyboard of claim 10 wherein the security access member provides secured access to the keyboard module.

12. The keyboard of claim 10 wherein the security access member provides secured access to at least one of the detachable module or the keyboard module for communication with the processing device.

13. The keyboard of claim 10 wherein the security access member comprises a fingerprint reader.

14. The keyboard of claim 10 wherein the security access member in the detachable module stores data to verify user input to provide security access.

15. The keyboard of claim 1 wherein the at least one input member comprises at least one of a button, a knob, a roller, or a keypad.

16. The keyboard of claim 1 wherein the detachable module includes at least one input member for providing input to the processing device and/or the keyboard module, the at least one input member performing an identical function in the docked mode and the undocked mode.

17. The keyboard of claim 1 wherein the detachable module includes at least one input member for providing input to the processing device and/or the keyboard module, the at least one input member performing different functions in the docked mode and the undocked mode.

18. The keyboard of claim 1 wherein the detachable module does not communicate with the keyboard module in the undocked mode.

19. The keyboard of claim 18 wherein the detachable module is configured to communicate with the processing device in the undocked mode.

20. The keyboard of claim 1 wherein the detachable module further comprises a memory card reader.
